(19) United States
(12) Patent Application Publication
(10) Pub. No.: US 2004/0107628 A1
(43) Pub. Date: Jun. 10, 2004

(54) Self-orienting fishing lure

(76) Inventor: Scott Mueller, Huntington Beach, CA (US)

Correspondence Address: FULWIDER PATTON LEE & UTECHT, LLP, 200 OCEANGATE, SUITE 1550, LONG BEACH, CA, 90802, US

(21) Appl. No.: 10/309,542

(22) Filed: Dec. 4, 2002

(51) Int. Cl. A01K 85/00

(52) U.S. Cl. 43/42.39

(57) ABSTRACT

A lipless fish lure having a tear-shaped body with a head portion and a tapered rear portion, the body having a weight inserted into a cavity formed in the underside of the body and cooperating with the body to form a substantially vertical moment axis about which the head and the rear portions pivot in correspondence with one another, the weight further cooperating with the body causing the body when towed to travel in a substantially upright position.

### BACKGROUND OF THE INVENTION

The fishing art is replete with examples of attempts to provide a fishing lure that accurately imitates a natural bait fish. Such attempts have included lures that are colored, for example, to imitate the natural coloring of a bait fish to make it further attractive the predator 5 species sought. Such coloring has included a darkened dorsal region and a light colored underside of a lure body. Such coloration is a naturally defensive camouflage scheme to make a fish appear invisible when viewed skyward from below and when viewed from above toward the darkened background of the water below. Other features such as a pair of artificial eyes placed on the upper portion of the head end of a lure body have also been known to more closely imitate a bait fish.

Although natural bait fish are often colored in a camouflaged scheme, predator fish are acutely sensitive to movement, especially movement that appears to be characteristic of potential prey. Camouflage coloring, for example, is thus helpful to make an imitation appear realistic. Realistic movement of such an imitation will exponentially increase the likelihood of predator interest.

Using a lure with such an imitative color scheme, however, is most effective if the body of the lure can be properly oriented and maintained during towing or retrieve in a generally upright position, the darkened dorsal portion facing the skyward and the light colored underside facing toward the depths. Towing the lure in an inverted position, the underside being rolled to face the sky is not a natural or effective way to present an imitation.

Orienting a lure to be towed in the upright position has been known in the art to be advantageous to drawing predacious strikes. Fishing lures designed to be towed in an upright position are well known in the art. Lipped lures, for example, help orient the lure in a generally upright position during retrieve. However, the lip of the lure causes a substantial drag when towed and creates unnatural turbulence.

Moreover, fishing lures towed in a fixed upright position is not desirable. Live bait fish, for example, do not move through the water in a fixed position. Live bait fish are propelled through the water by a wriggling body. It is also well known in the art that wriggling movement of artificial lures induce strikes from predator fish.

Jointed and articulating lures with multiple body parts have been known to provide a somewhat simulated wriggling action in the art. Lures made from flexible materials such as soft plastics or rubbers which include tails have been known to provide a wriggling action as the flexible lure is towed through fish-holding water.

Fish-holding water, however, is seldom a stagnant environment. Turbulence and currents frequently occur throughout a fish-holding environment. In a typical impoundment of fish-holding water, for example, are currents and turbulence created from forces developed, for example, by surface winds, wave action, water temperature variation, water density variation, thermocline layers, passing boats, passing fish, and reaction to currents by stationary objects, etc. In the ocean, additional currents may be imparted by wave action and tidal influences. Water movement and currents are, of course, more profound in rivers and streams. Live fish, for example, react to such currents and turbulent influences by movement through body adjustment. Thus, a lure's reaction to such turbulent influences is also important to create lifelike and desirable fish-imitating action.

What has been long desired in the fishing art is a lure that maintains a substantially upright position, imitates realistic and lifelike reaction to a wide range of turbulent conditions, and does not create excess drag.

### SUMMARY OF THE INVENTION

The invention is directed to a lipless fish lure having a tear-shaped body with a head portion and a rear portion, the body having a weight inserted into a cavity formed in the underside of the body and cooperating with the body to form a substantially vertical moment axis about which the head and the rear portions pivot in correspondence with one another, the weight further cooperating with the body causing the body when towed to travel in a substantially upright position.

These and other features and advantages of the present invention will become apparent from the following detailed description which taken in conjunction with the accompanying drawings, further describes and illustrates by way of example the principles of the invention.

### BRIEF DESCRIPTION OF THE DRAWINGS

FIG. 1 is a side view of a preferred embodiment of the present invention;

FIG. 2 is a frontal view of a preferred embodiment of the present invention;

FIG. 3 is a sectional view along the lines depicted in FIG. 2;

FIG. 4A is a partial top sectional view along the lines shown in FIG. 3;

FIG. 4B is a top view of the lure with a cutaway portion depicting the substantially vertical moment axis and lateral swinging movement of the lure body about the moment axis as the lure is towed;

FIG. 5 is a partial side sectional view of a preferred embodiment of the present invention;

FIG. 6 is a partial top sectional view along the lines shown in FIG. 5;

FIG. 7 is a perspective view of a preferred embodiment of the present invention;

FIG. 8 is a side sectional view of a preferred embodiment of the present invention;

FIG. 9 is a full cross-sectional view along the lines shown in FIG. 8;

FIG. 10 is a side view of a long bodied preferred embodiment of the present invention;

FIG. 11 is a side view of a short bodied preferred embodiment of the present invention;

FIG. 12 is a side view of an intermediate bodied preferred embodiment of the present invention;

FIG. 13 is a sectional side view of a preferred embodiment of the present invention;

FIG. 14 is a sectional side view of a preferred embodiment of the present invention; and

FIG. 15 is a sectional side view of a preferred embodiment of the present invention.

### DETAILED DESCRIPTION OF THE PREFERRED EMBODIMENTS

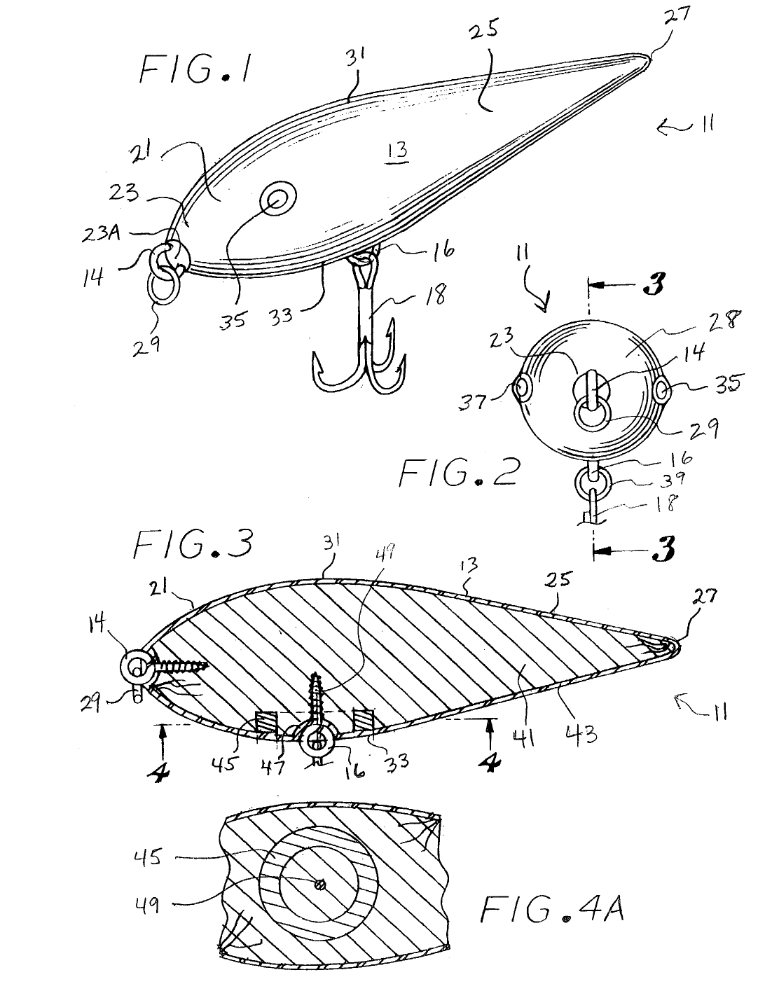

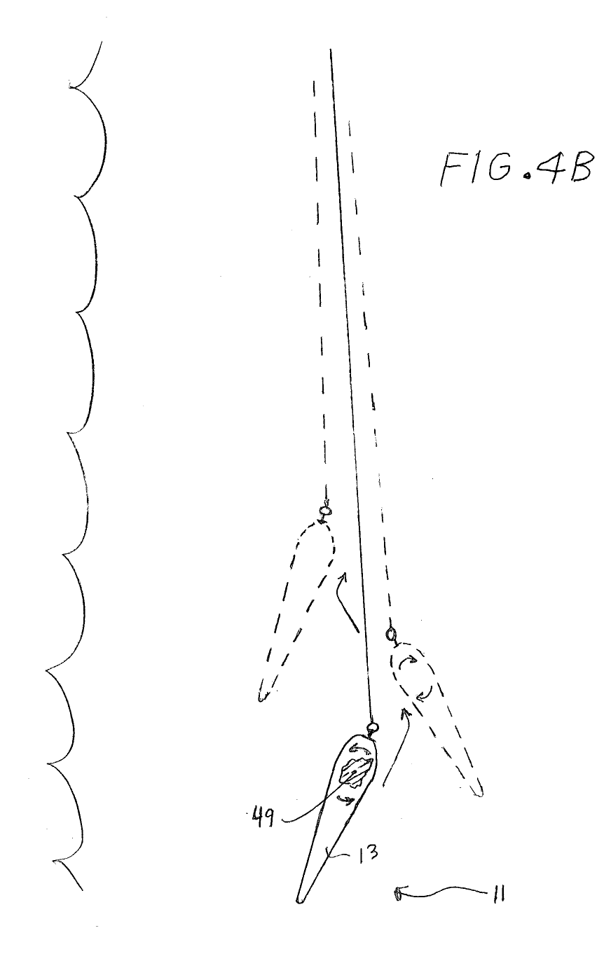

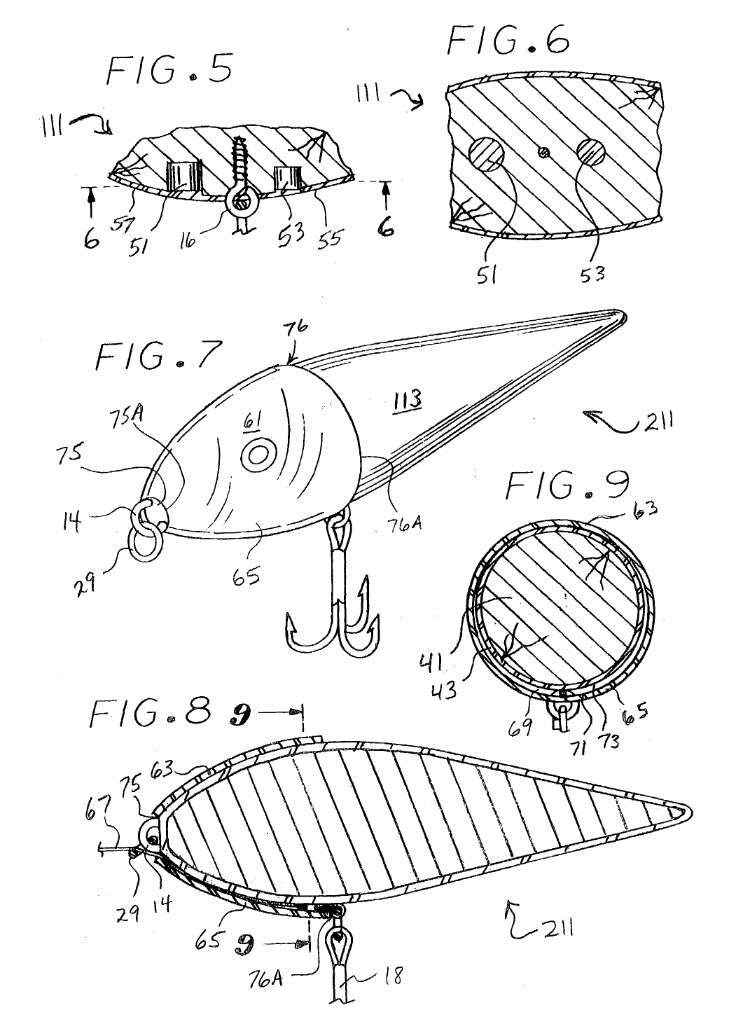

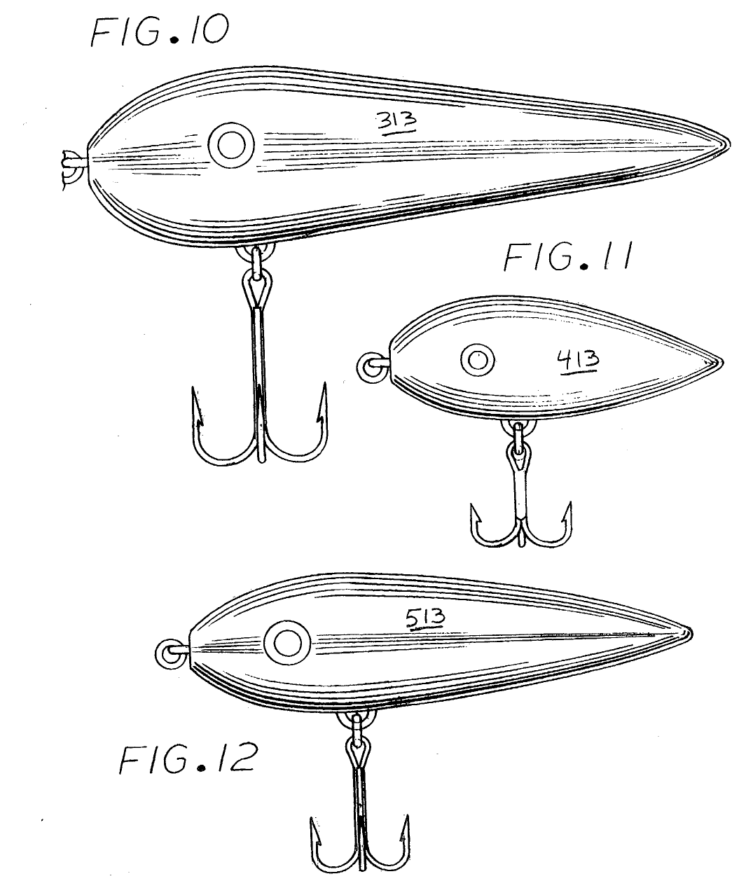

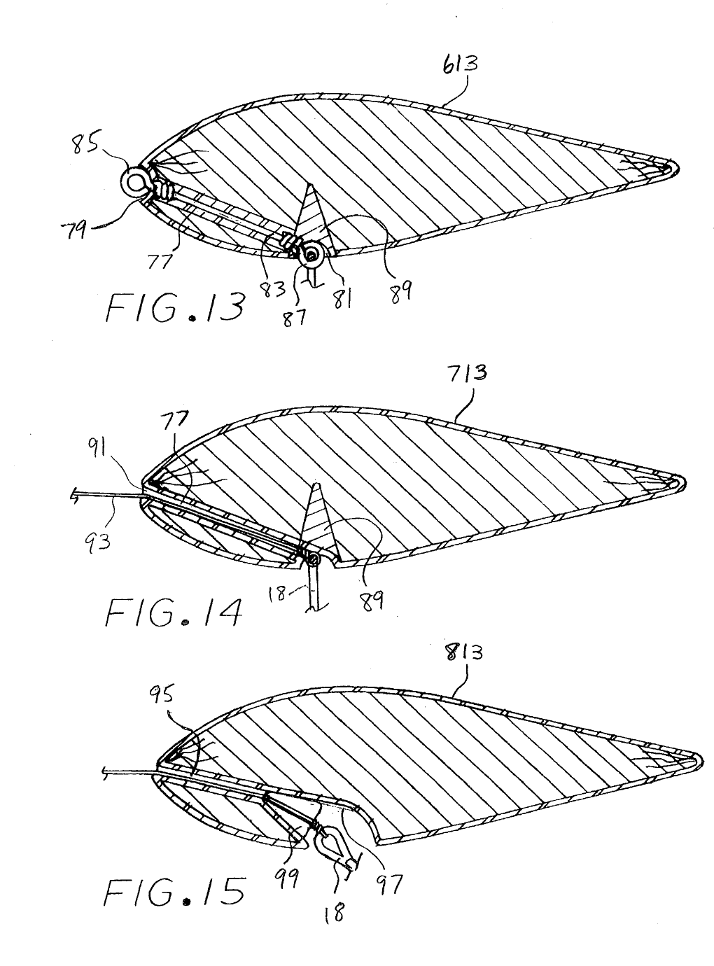

A preferred embodiment of the lure is shown in FIGS. 1-4B in the shape of a lipless plug. Referring to FIG. 1, the lure 11, has a body 13 in the shape of a teardrop, the body having a head portion 21 in an arcuate conical shape with a nose 23 terminating in a nose tip 23A, and a tapered rear section 25 terminating in a rear end 27. Proportionally, the body 413 shown, as measured along its longitudinal axis from the nose tip to the rear end, is about 5.2 inches long. At its widest point, where the head transitions to the rear portion, the body is about 1.5 inches wide.

Attached to the nose 23 is a line attachment device 14 in the form of a tow loop to receive fishing line or other line connection devices, as desired, such as a swivel, a split ring, or the like as is known in the art. In this preferred embodiment, the tow loop is shown molded into the nose of the body 13. Shown connected to the tow loop is an optional tow ring 29. The tow ring may alternatively serve to as a device to attach the towing line and may be permanently or removably connected to the tow loop, as desired, such as, for example, a split ring.

The body 13 also has a dorsal portion 31 and an underside 33. Attached to the underside is a hook attachment device 16 with a hook 18 coupled thereto. In practice the hook device and positioned behind the nose about ½ to ⅓ the overall length of the body. Preferably, the hook attachment device is positioned within the second fifth of the length of the body as measured from the end of the nose to the end of the rear portion along the longitudinal axis of the body. In this embodiment, the hook attachment device is about 1.6 inches from the tip of the nose.

FIG. 2 shows generally the lure 11 from a frontal perspective, the lure having a face 28 in an arcuate conical shape with a nose 23 and a pair of artificial eyes, a port eye 35 affixed to the port side of the body and a starboard eye 37 affixed to the starboard side of the body. Shown on the underside is hook attachment device 16, hook 18, and a hook attachment ring 39 connected therebetween. The face and body may also take other shapes such as, for example, when viewed from the front, a generally horizontally ovoid shape to simulate a flatfish or the like or, for example, a vertically ovoid shape to simulate a variety of bait fish such as minnow, anchovy, smelt, bluegill, trout, mackerel, a parabolic shape including a rounded dorsal portion and a flattened underside, or a generally triangular shape.

FIG. 3 is a sectional view of a preferred embodiment along the lines indicated in FIG. 2, the vertical plane through the longitudinal axis of the body 13. In the present embodiment, the body 13 of the lure 11 is formed from a core 41 formed of wood, the core being covered by an epoxy skin 43. The core may alternatively be formed from other relatively light weight materials such as, for example, plastic or polymeric foams or the like, and may contain voids for increased buoyancy. Optionally, the body may be formed from flexible rubberized or silicone based materials. The skin may, alternatively, be formed from plastic, resin, or polymeric material as is known in the art, or may, for example, be formed from fibrous material such as fiberglass or the like and may be impregnated with resin, polymeric material, or the like. Alternatively, the body may be formed, for example, of a single material such as plastic, wood, or polymeric foam, and may optionally be coated with paint or varnish material. The body may be finished as is known in the art to appear like the body of a naturally occurring bait fish including, for example, darkened color on the dorsal portion and light coloring on the underside.

Attached to the underside 33 of the body 13 is the hook attachment device 16. In this embodiment, the hook attachment device is a metal eye screw having a shaft 49 screwed into the body as shown in FIG. 3. The hook attachment device may alternatively be in the form of a loop, partial loop, or small hook formed from one or more of a variety of materials such as, for example, metal, plastic, monofilament line or other materials as are known in the art to receive the eye or shank of a single, treble, or other type of fish hook. In some smaller examples I employ the eye screw and its bonding resin as the balancing weight thus making it unnecessary to add any additional weight. As will be appreciated by those skilled in the art the hook attachment may be by a swivel known by the trademark ROSCO or a ball bearing pivot sold under the trademark SAMPO. In the present embodiment, the body is countersunk 47 to lower the profile of the hook attachment device.

Imbedded into the underside 33 of the body 13 is a weight 45 which may be in the shape of a ring. The ring weight 45 is horizontally positioned in the body and about a portion of the hook attachment device 16. The weight is made of a heavier material than the body and can be formed from metals such as lead or the like or from other materials known in the art. The weight ring adds a small amount of weight to the lure 11 and functions to cause the lure to roughly maintain an upright position, the weight acting as a ballast as the lure is towed through the water. Upright is defined as a towing position where in relation to the dorsal portion 31 and the underside 33, the dorsal portion is highest in the water and the underside is aligned vertically beneath it. The maintenance of a generally upright position presents the lure in a proper state to predator fish sought by the fishing party and at the same time serves to prevent line twist by preventing rollover of the lure. Maintenance of a generally upright position maintains the darkened dorsal portion of the body nearest the surface as it would naturally occur and the light colored underside vertically beneath the darkened dorsal portion. Other coloring schemes may be employed including, for example, use of a single color, reflective materials, depiction of lateral lines along the port and starboard sides of the body, gill plates, mouth parts, etc. Weight rings of different weights may be provided, as desired, depending on lure size and towing depth desired.

The core 41 of the present embodiment is made of wood, foam, or other rigid material that provides buoyancy in water. The light weight core causes the body 13 to be affected by a wide range of turbulent forces when in the water. These turbulent effects frequently cause the body to roll somewhat about its longitudinal axis in one direction or the other and may also cause the body at times to pitch forward or rearward. The weight ring 45 corrects the roll and/or the pitch as the case may be and returns the body to a substantially upright position. In combination with the core, the weight ring 45 acts to generally maintain the body in an upright position as the lure travels generally horizontally through the water during towing. Preventing body roll and pitch and urging return to a substantially upright position, the weight forms a relatively stable substantially vertical moment axis about which the body may laterally pivot. This reaction to turbulence advantageously simulates how a live fish would react under such circumstances. Reacting in this way to turbulence is a key signal to a predator fish that the lure appears to be alive and thus will increase the chance it will draw the predator to strike it. This embodiment provides such life-like movement without a conventional tail or jointed or articulated body portions and without the excess drag of a lipped plug.

FIG. 4A is a partial sectional view of the lure 11 along the line indicated in FIG. 3. This figure shows the ring shape of the weight ring 45, the ring being centered coaxially around the vertical axis of the shaft 49 of the hook attachment device 16. In this embodiment, the shaft is placed within the second fifth of the length of the body 13 and the weight of the ring is distributed evenly about the horizontally positioned ring 45. When towed through the water by a typical fishing apparatus including rod, reel, and line, the upward angle of the line tensioned between the line attachment device of the lure and the rod tip causes the lure to orient itself in a substantially horizontal swimming position. In this towed position, the vertical axis of the shaft of this embodiment forms a relatively stable moment about which the body may laterally pivot. Being connected to the towing line, the body is directed to follow the tow path during towing or retrieving conditions unless overcome by other forces.

In addition to other turbulent forces frequently imparted on the body during towing, the head 21 of the body 13 imparts turbulent forces to the trailing portion of the body including the rear portion 25. The horizontal positioning of the weight ring 45 allows the body to be affected by turbulence applied laterally to the port and starboard sides of the body. The weight ring 45, however, does not react with an appreciable return influence to laterally applied force.

FIG. 4B shows a top view of the lure 11 with a cutaway portion depicting the substantially vertical moment axis 49 and lateral swinging movement of the body 13 about the moment axis as the lure is towed. In operation, head-generated or other turbulence causes the head of the body to shift laterally from the tow path. The rear portion of the rigid body responds by swinging about the moment axis formed at the vertical axis of the horizontally positioned weight ring, swinging laterally outwardly in the opposite direction of the head. The head thus veers from the tow path and experiences increasing load from the tow line via the line attachment device urging the head to return to the tow path as distance from the tow path increases. Eventually overcome by the increased load, the head quicky turns back toward the tow path. Simultaneously as the head changes direction, the rear portion is correspondingly swung about the moment axis in the opposite direction. Once turned, the pulling load on the head decreases as it travels toward and across the tow path. This decreased pulling load is somewhat analogous to a water skier feeling less pulling force from a ski rope as the skier changes direction from adjacent the boat's wake to cross the wake directly behind the boat.

As a result of the decreased pulling load on the head of the lure, the head of the body crosses the tow path, veering from the path until once again the pulling load increases on the line attachment device until the head is overcome by the increased load and is forced to change direction back toward the tow path. As the head turns, the rear portion rigidly and correspondingly swings about the moment axis in the opposite direction, not unlike the tail of a weathervane reacting to a shifted wind in directionally rigid opposition to its front portion. This swinging action is repeated as the head changes direction across the tow path and the rear portion correspondingly responds about the moment axis. This repeated action causes the lure to appear to swim in a wriggling fashion closely imitating movement of a bait fish. The weight thus advantageously cooperates with the body causing the body when towed to travel in a substantially upright position and form a substantially vertical moment axis about which the body is relatively free to wriggle side to side in life-like fashion, the moment axis being formed in this embodiment through the vertical axis of the horizontally positioned weight ring.

Frequency of direction shift can be adjusted by adjusting the mass of the weight. Increased weight provides for greater moment inertia, thus reducing the frequency of direction shift.

Fishing a downwardly diving lure is also known to be an effective strategy for attracting strikes by predator fish. Fish have been known to ferociously strike a lure on the drop before a lure reaches its anticipated depth.

FIGS. 5 and 6 show a preferred embodiment of the lure of the present invention. In this embodiment, the weight device includes a fore weight 51 and an aft weight 53 ecured in the underside 55 of the body 111 in the vertical plane of the longitudinal axis of the body. The weights may be press fit into voids formed in the body and/or covered over by skin covering 57.

FIG. 6 is a partial sectional view of the embodiment disclosed along the line as shown in FIG. 5. As shown in both figures the fore weight is larger than the aft weight. In this embodiment, the fore weight is also heavier than the aft weight causing the lure to travel in the water in a generally downward direction. The fore and aft weights add ballast to the lure urging the body of the lure to travel in an upright, but in a somewhat downwardly diving position. Positioned in the underside of the second fifth of the body length, the weights also urge return of the body from roll about the longitudinal axis of the body and form a substantially vertical moment axis about which the head and rear portions are relatively free to laterally pivot. The lure when towed reacts to turbulence generated by the head of the body and varied tow line forces to cause the body to wriggle laterally in a side to side action simulating a swimming bait fish. The fore and aft weights may be selected to provide the diving angle desired, the weights urging return of the body to the preferred diving angle should the angle be altered by turbulence. The heavier fore weight further helps provide for advantageous jigging action of the lure upon intermittent towing or retrieve.

FIG. 7 shows the lure 211 with a conically arcuate jacket 61 covering the head of the lure body 113, the jacket having a dorsal portion 63 and an underside portion 65. The jacket also has an interior surface 71, an exterior surface, an opening 75 at its front end bounded by a front edge 75A, and a rear opening 76 to receive the head of the body, the rear opening bounded by a rear edge 76A. The jacket may be formed from metal, plastic, or other materials known in the art. Depending on the material used, the weight of the jacket may cause the head to tip downwardly providing diving orientation. Counterbalancing rear weight may be provided to adjust the diving angle as desired.

As FIGS. 8 and 9 show, the interior surface of the jacket is formed to complementally fit over the head having an outer surface 73 and provides a passage 69 through which a tow line 67 may be threaded between the inner surface 71 of the jacket and the outer surface 73 of the head. The jacket may be attached to the head, for example, by conventional epoxies, fasteners, or may be secured in place, for example, by a inwardly turned rear edge gripping the body. A tow line 67 is threaded through the opening 75 in the front end of the jacket and through the passage 69 and tied to the hook attachment device 16. As shown is FIG. 8, the line is threaded through the tow ring 29, the tow ring and the line attachment device 14 being optional for operation of this embodiment. The edge 75A of the opening in the front end of jacket is rounded and smooth to prevent line abrasion.

Also embraced within this invention, the lure with and without the ballast weight, may be positively, neutrally, or negatively buoyant as desired. Alternatively, the tow line of the present embodiment may be threaded through the opening 75 in the front end of the jacket and through the passage 69 and tied directly to the hook 18. Should a fish be hooked and the body together with the jacket be positively buoyant, they may advantageously and floatingly slide up the line protecting it from abuse by the fish. Similarly, should the hook become snagged and the body and jacket are positively buoyant, they may advantageously and floatingly slide up the line and be collected for later use. While adjacent the hook, the jacket may also advantageously shield use of wire leader, often used for targeting species known to abrade and cut through standard fishing line with powerful and sharp teeth.

FIGS. 10-12 show profiles of preferred embodiments of weighted lipless plug lures of the present invention. Size and shape of the lure bodies affect the frequency and extent of side to side movement of the lure. These three figures show embodiments ranging from an aggressively tapered head and elongated rear portion of body 313, FIG. 10, as may be used, for example, for large fast moving predator species, to a less aggressively tapered head and a relatively shortened tapered rear portion of a body 413 for quick turning smaller species, FIG. 11, to an intermediately tapered body 513 suitable also for a variety of fishing applications FIG. 12. These preferred embodiments are not necessarily drawn to actual size nor is it to be understood that the present invention is to be limited to the sizes depicted or described.

For example, the high speed lure shown in FIG. 10 may range up to 26 inches long for targeting large fast moving species. Proportionally, the body 313 shown, as measured along its longitudinal axis, is about 6.5 inches long and the hook attachment device is about 1.75 inches from the tip of the nose. At its widest point, the body is about 1.7 inches wide. A more streamlined embodiment with, for example, a less aggressively tapered head than is shown may be used for high speed trolling or fast retrieve for among the fastest of target fish. Such a streamlined taper and a long body provide, over an equal distance, relatively few lateral shifts in direction.

The body 413 of the lure shown in FIG. 11 may be sized to as small as one inch in length and is suitable to target bass, trout, panfish, and similarly sized fish. Proportionally, the body 413 shown, as measured along its longitudinal axis, is about 3.25 inches long, the hook attachment device being about 1.25 inches from the tip of the nose. At its widest point, the body is about 1.3 inches wide. This relatively stunted rear portion provides less mass about which must be overcome to turn about the substantially vertical moment axis. With less moment inertia to overcome, such a stunted taper provides relatively more frequent turns about the moment axis over a given distance. A more aggressively tapered head than shown will provide for additionally frequent shifts in direction of the lure, especially effective when trolled or retrieved slowly for simulating relatively slow moving, but darting bait fish.

The body 513 of the lure shown in FIG. 12 may also be variably sized being suitable to target a wide variety of predator species. Proportionally, the body 513 shown, as measured along its longitudinal axis, is about 4.9 inches long, the hook attachment device being about 1.5 inches from the tip of the nose. At its widest point, the body is about 1.4 inches wide.

FIGS. 13-15 show additional preferred embodiments of the present invention. In FIG. 13, the body 613 is formed with a channel 77 angling downwardly and rearwardly from an opening 79 in the nose of the body through an opening 81 in the underside of the body. A link 83 is threaded through the channel and is secured to a line attachment loop 85 inserted in the nose and at its opposite end to a hook attachment loop 87 inserted in the underside. The link may be comprised of fishing line, wire, or other material. The openings in the nose and underside are countersunk to draw the loops partially into the body. A ballast weight 89 is inserted into a cavity in the underside above the opening in the underside. In cooperation with the body, the weight operates to maintain the body in a substantially upright position when the lure is towed through the water and forms a relatively stable substantially vertical moment axis about which the head and rear portions pivot. The weight in the present embodiment is conically shaped, but may also be shaped in the form of a pyramid, a dome, or other shape having a relatively higher center of gravity compared to a ring-shaped horizontally positioned weight. Compared to a similarly positioned horizontal weight, when turbulence is experienced such a raised center of gravity in the weight allows relatively more roll about the longitudinal axis and slightly more pitch in the fore and aft directions and thus provides somewhat greater body action provoking more aggressive strikes. Other weight shapes and sizes may also be employed as desired.

In FIG. 14, the channel 77 is terminated at nose opening 91, this nose opening having a smooth flared transition to prevent line chaffing as no line attachment device is provided on the nose. A tow line 93 is threaded through the channel, the terminal end of the line is tied directly to the hook 18. The hook is slideably drawn up to the opening formed in the underside of body 713 during towing. A weight 89 with relatively high center of gravity is also provided above the opening in the underside. In cooperation with the body, the weight substantially maintains the body during towing in a substantially upright position and forms a relatively stable substantially vertical moment axis about which the head and rear portions pivot. The channel may take a variety of forms including, for example, a tube shape and provide for the line to slide therethrough.

In the event a positively buoyant body is employed in the present embodiment, should the hook become snagged, such body may advantageously slideably float up the line to the surface and be recovered thereby preserving the body of the lure for future use. Similarly, should a fish be hooked by this buoyant embodiment, the body may advantageously and floatingly slide up the line protecting it from abuse by the fish. While adjacent the hook, the channel may also advantageously shield use of wire leader, often used for targeting species known to abrade and cut through standard fishing line with powerful and sharp teeth.

In FIG. 15, a channel 95 is provided with an enlarged underside opening 97 forming a niche to correspondingly receive a sinker weight 99 which is attached to the tow line above the hook 18. In this embodiment, when the sinker is slideably drawn up into the niche 97, the sinker nests therein and cooperates with the body 813 to maintain the body during towing in a substantially upright position and form a relatively stable substantially vertical moment axis about which the head and rear portions pivot. Neither the hook nor the sinker is directly or indirectly affixed to the body 813.

Advantageously, should the hook become snagged, a buoyant body of the present invention may freely float up the line to the surface and be recovered thereby preserving the body of the lure for future use. Similarly, should a fish be hooked by this embodiment, the body may floatingly slide up the line protecting it from abuse by the fish. While adjacent the hook, the channel may also advantageously shield use of wire leader, often used for targeting species known to abrade and cut through standard fishing line with powerful and sharp teeth.

Having described only typical forms and applications of the present invention, it is not intended that the invention be limited to the specific details herein set forth. While a particular form of the invention has been illustrated and described, it will also be apparent to those skilled in the art that various modifications can be made without departing from the spirit and scope of the invention. Accordingly, it is not intended that the invention be limited except by the appended claims.

What is claimed is:

1. A fish lure comprising:
a tear-shaped body configured with an arcuate conically-shaped head portion having a nose with a nose tip and a tapered rear portion terminating in a rear end, the body further having a dorsal portion, an underside, and a longitudinal axis;
a line attachment device on said nose;
a hook attachment device mounted on the underside within the second fifth of the length of the body as measured along the longitudinal axis from tip of the nose to the rear end of the rear portion;
a cavity formed in the underside of the body;
a weight device inserted in the cavity and cooperating with the body to form a substantially vertical moment axis about which the head and the rear portions pivot in opposing correspondence with one another, the weight device further cooperating with the body causing the body when towed to travel in a substantially upright position; and
a hook connected to the hook attachment device.

2. The fish lure as set forth in claim 1 wherein said moment axis is relatively stable.

3. The fish lure as set forth in claim 1 wherein said weight device includes portions positioned fore and aft of said hook attachment device.

4. The fish lure as set forth in claim 1 wherein said weight device is ring-shaped.

5. The fish lure as set forth in claim 4 wherein weight is evenly distributed about the ring.

6. The lure as set forth in claim 1 wherein said weight device has a relatively high center of gravity.

7. The lure as set forth in claim 1 wherein said body and weight device together are positively buoyant.

8. The fish lure set forth in claim 1 wherein said hook attachment device includes a hook attachment ring.

9. The fish lure set forth in claim 1 wherein said line attachment device includes a tow ring.

10. The fish lure of claim 1 that includes a jacket is complementally mounted over said head.

11. The fish lure of claim 1 wherein the length of the body may be about one inch to about 26 inches long.

12. The fish lure set forth in claim 1 wherein said body is about 6.25 inches long, said moment axis is relatively stable, said weight device includes portions fore and aft of said hook attachment device, said hook attachment device includes a hook attachment ring, and said line attachment device includes a tow ring.

13. A fish lure comprising:
a tear-shaped body configured with an arcuate conically-shaped head portion having a nose with a nose tip and a tapered rear portion terminating in a rear end, the body further having a dorsal portion and an underside and an exterior surface;
a jacket shaped to complementally fit over the head of the body, said jacket having an interior surface, a front opening, and a rear opening and configured to cooperate with said head to form a passage extending from of the front opening to the rear opening adjacent the underside of the body and between the outer surface of the body and the inner surface of the jacket, said passage configured to receive a towing line threaded through the passage; and
a hook connected to the towing line exiting the passage at the rear opening of the jacket.

14. The lure as set forth in claim 13 wherein said passage is further configured to allow the line to slide therein.

15. The lure as set forth in claim 13 wherein said nose includes a line attachment device.

16. The lure as set forth in claim 13 wherein said passage tube-shaped.

17. A fish lure body for use with a weight device of a predetermined configuration, said body comprising;
a tear-shaped body configured with an arcuate conically-shaped head portion having a nose with an opening therein and a tapered rear portion terminating in a rear end, the body further having a dorsal portion and an underside;
a channel angling downwardly and rearwardly in said body from said nose opening to an opening in the underside, said channel cooperating with said nose opening and underside opening to receive line threaded from the nose opening to the underside opening;
a cavity formed in the underside;
said cavity configured to receive a weight device, said weight device to be positioned to cooperate with the body to form a relatively stable substantially vertical moment axis about which the head and the rear portions pivot in correspondence with one another, the weight device further cooperating with the body causing the body when towed to travel in a substantially upright position.

18. The fish lure body of claim 17 wherein the weight device is positioned in the cavity.

19. The fish lure body of claim 17 wherein the cavity is a niche, said weight device configured to be connected to the line threadedly exiting the underside opening and is formed correspondingly nest in position in the niche when slideably drawn therein.

20. The fish lure body of claim 19 wherein the channel is tube-shaped.
